(19) United States
(12) Patent Application Publication
(10) Pub. No.: US 2021/0113863 A1
(43) Pub. Date: Apr. 22, 2021

(54) NASAL MASK

(71) Applicant: Airgle Corporation, Holbrook, NY (US)

(72) Inventor: Yang Zhen Lo, Holbrook, NY (US)

(21) Appl. No.: 16/658,182

(22) Filed: Oct. 21, 2019

(51) Int. Cl. A62B 23/06; A62B 23/02; A62B 18/08; A62B 18/00; A62B 7/10

(52) U.S. Cl. CPC A62B 23/06; A62B 23/025; A62B 7/10; A62B 18/006; A62B 18/084

(57) ABSTRACT

Disclosed is a nasal mask assembly. An example mask assembly includes a first part, a filter, a second part, and at least two straps attached to the second part. The first part includes a base configured to engage the face surface around a nose of a user and a filter support extending from the base and defining a breathing chamber. The filter support includes a first outlet and at least one first inlet. The filter is placed over the filter support and covers the first inlet. The second part can be configured to engage the base and a portion of the filter support around the first outlet and to cover a combination of the filter support and the filter. The second part includes a second outlet and a second inlet configured to be positioned against the first outlet.

### TECHNICAL FIELD

This disclosure generally relates to respirators and breathing masks, and more particularly to nasal masks.

### BACKGROUND

Face mask and nasal mask are widely used for filtering air during breathing and treating respiratory diseases. Anti-smog face masks currently available on the market are designed to cover both the nose and mouth of a user. Covering both the nose and mouth can be uncomfortable for the user. Filter layers of a face mask can be damped when the user breathes air out or opens the mouth for talking. Additionally, the user of the face mask may breathe in unfiltered or polluted air due to air leakages around the nose because the face mask may not fit the user's nose precisely. The mask may not fit all users because different users have different nose sizes and shapes.

Some currently used medical nasal respirators are designed to be inserted into user's nostrils for filtering air. As a result, users may feel very uncomfortable. In addition, because different people have different nostril sizes, nasal respirators might be too small for some users, so they cannot be inserted too deep inside the nostrils. On the other hand, nasal respirators may be too big for other users, so they cannot be inserted into the nostrils at all.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to one example embodiment, a nasal mask assembly is provided. The nasal mask assembly may include a first part. The first part may include a base configured to engage a face surface around a nose of a user and a filter support extending from the base and defining a breathing chamber. The base may include a first base part and a second base part connected to each other. The first base part may be configured to engage the face surface around the nose of the user and the second base part may be configured to engage the second part of the nasal mask assembly. The filter support may include a first outlet and at least one first inlet. The nasal mask assembly may further include a filter configured to be placed over the filter support and to cover the first inlet. The nasal mask assembly may further include a second part. The second part can be configured to engage the base and a portion of the filter support around the first outlet. The second part may also cover a combination of the filter support and the filter. The second part may include a second outlet and at least one second inlet. The second outlet can be configured to be positioned against the first outlet. The nasal mask assembly may further include a one-way valve configured to be secured within the second outlet to allow airflow from the breathing chamber and to prevent the airflow to the breathing chamber. The nasal mask assembly may include at least two straps attachable to the second part and configured to secure a combination of the first part, the filter, and the second part to the face surface of the user.

The filter support can be made of a hard-plastic material or a soft material having a predetermined hardness, such as, for example, a silicone material. The at least the first base part of the base can be made of a soft material, such as, for example, the silicone material. The filter support and the filter can be substantially of a conical shape or substantially of a polygon pyramid shape. In some embodiments, the filter support and the filter can be substantially of a planar shape.

The portion of the filter support around the first outlet can be made of a soft material, such as a silicone material or ethylene-vinyl acetate cotton. The one-way valve may include a silicone check valve. The two straps may include head straps and ear straps. The filter can be made of a material configured to be moistened with at least one liquid medicine. The material of the filter may be configured to filter particles having a size/diameter that is less than a predetermined size/diameter, including but not limited to particulate matter that have a diameter of less than 10 micrometers (PM10) or less than 2.5 micrometers (PM2.5), dust, pollen, pet dander, tobacco smoke, airborne pollutants, and other pollutants.

The second part may have the at least one second inlet in the form of a mesh of openings. The nasal mask assembly may further include at least one electrically driven fan installed within the second inlet. The electrically driven fan can be configured to pump air towards the filter and the filter support.

The second inlet can be also configured to receive at least one hose. The hose can be configured to provide an airflow from an external air pump device.

The nasal mask assembly may further include a first breathing sensor for exhaled air installed within the second outlet and/or a second breathing sensor for inhaled air installed on the at least one second inlet. Each of the breathing sensors can be configured to measure sensor data including a frequency and a strength of breathing of the user. The nasal mask assembly may further include a radio transmitter installed inside the second part and coupled with at least one of the first breathing sensor and the second breathing sensor. The radio transmitter can be configured to transmit the sensor data to at least one computing device. In an example embodiment, the radio transmitter can be replaced with a wired transmitter, for which a wire connector can be provided via one of the straps.

According to another example embodiment, a method for providing a nasal mask assembly is provided. The method may include providing a first part. The first part may include a base configured to engage a face surface around a nose of a user and a filter support extending from the base and defining a breathing chamber. The filter support may include a first outlet and at least one first inlet. The method may include providing a filter configured to be placed over the filter support and cover the first inlet. The method may include providing a second part configured to engage the base and a portion of the filter support around the first outlet. The second part can be configured to cover a combination of the filter support and the filter. The second part may include a second outlet and at least one second inlet. The second outlet can be configured to be positioned against the first outlet. The method may include providing a one-way valve configured to be secured within the second outlet to allow airflow from the breathing chamber and to prevent the airflow to the breathing chamber. The method may include providing at least two straps attachable to the second part and configured to secure a combination of the first part, the filter, and the second part to the face surface of the user.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 is an exploded view of an example mask assembly, according to an example embodiment.

FIG. 2 shows a first part and a second part of a nasal mask assembly, according to some example embodiments.

FIG. 3A shows a user wearing a nasal mask assembly, according to an example embodiment.

FIG. 3B shows a user wearing a nasal mask assembly, according to another example embodiment.

FIG. 4 shows a second part of the nasal mask assembly, according to some example embodiments.

FIG. 5 shows a second part of the nasal mask assembly, according to some other example embodiments.

FIG. 6 is a block diagram showing an example system for monitoring and processing breathing data of a user using a nasal mask assembly, according to some example embodiments.

FIG. 7 is a flow chart showing a method for providing a nasal mask assembly, according to some example embodiments.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Embodiments of this disclosure generally relate to respirators and breathing masks, and, specifically, to nasal masks. Some embodiments of the present disclosure provide a nasal mask assembly. The nasal mask assembly may allow a user to inhale through an air filter and exhale through a one-way valve. The filter can be moistened with liquid medicine for treatment of one or more respiratory diseases. The filter can be made of a material configured to filter particles having a size/diameter that is less than a predetermined size/diameter, including but not limited to particulate matter that have a diameter of less than 10 micrometers (PM10) or less than 2.5 micrometers (PM2.5), dust, pollen, pet dander, tobacco smoke, airborne pollutants, and other pollutants.

One advantage of the nasal mask assembly disclosed herein as compared to existing breathing masks is that the nasal mask assembly does not interfere with the mouth area of the user. Therefore, the user may speak or eat comfortably when wearing the nasal mask assembly. Some embodiments of the present disclosure may also provide a nasal mask assembly having a larger breathing chamber than currently existing nasal masks, and, thereby, allowing the user to breath comfortably. Yet another advantage of the nasal mask assembly disclosed herein is that the nasal mask assembly can be adaptable to different sizes and shapes of noses of different wearers.

According to one example embodiment of the present disclosure, a nasal mask assembly may include a first part, a filter, a second part, a one-way silicone valve, an optional breathing sensor, a valve cap, and at least two straps. The first part may include a base configured to engage a face surface around a nose of a user. The base can include a first base part and a second base part connected to each other. The first base part may be configured to engage the face surface around the nose of the user and the second base part can be configured to engage the second part.

The first part may further include a filter support extending from the base and defining a breathing chamber. The filter support may include a first outlet and at least one first inlet. The filter can be configured to be placed over the filter support and cover the first inlet. The second part can be configured to engage the base and a portion of the filter support around the first outlet. The second part may cover a combination of the filter support and the filter.

Two approaches can be implemented to achieve the goal of sealing the gaps (or air leaks) between the first part and second part, specifically between the breathing chamber of the first part and the one-way valve of the second part. The first approach includes making a portion placed around the first outlet of the filter support out of a soft material and engaging the portion placed around the first outlet with the second part. The second part may have an engaging portion inside (for example, within a proximity of the one-way valve) to engage the first part, specifically, to engage the portion placed around the first outlet of the filter support. The engaging portion of the second part may be made out of a hard-plastic material or a soft material having a predetermined hardness and strength and configured to seal the gaps. Therefore, the portion placed around the first outlet of the first part can be made out of the soft material and the engaging portion of the second part may be made out of the hard-plastic material. The portion placed around the first outlet and the engaging portion can engage and prevent air leaks between the first part and the second part.

The second approach includes making the whole breathing chamber, i.e. the filter support including the first outlet and a tip of the first outlet, out of a hard-plastic material or a soft material having a predetermined hardness and strength. The engaging portion of the second part may be made out of a soft material intended to seal the gaps or air leaks. The engaging portion of the second part may engage the breathing chamber of the first part. Therefore, the filter support of the first part may be made out of the hard-plastic material and the engaging portion of the second part may be made out of the soft material. The filter support of the first part and the engaging portion may engage and prevent air leaks between the first part and the second part.

The second part may include a second outlet and at least one second inlet. The second outlet can be configured to be positioned against the first outlet. The one-way silicone valve can be configured to be placed within the second outlet to allow airflow from the breathing chamber and to prevent the airflow to the breathing chamber. The breathing sensor can be configured to be positioned within the second outlet. Alternatively or additionally, the breathing sensor can be configured to be positioned on the second inlet. The breathing sensor can be configured to measure sensor data including a frequency and a strength of breathing by the user. The valve cap can be configured to secure one of the one-way silicone valve or the breathing sensor to the second outlet. The valve cap may include at least one opening. The two straps can be attachable to the second part. The two straps can be configured to secure a combination of the first part, the filter, and the second part to the face surface of the user. The first part and the second part can be connected to each other via one or more fixing elements, for example, clips.

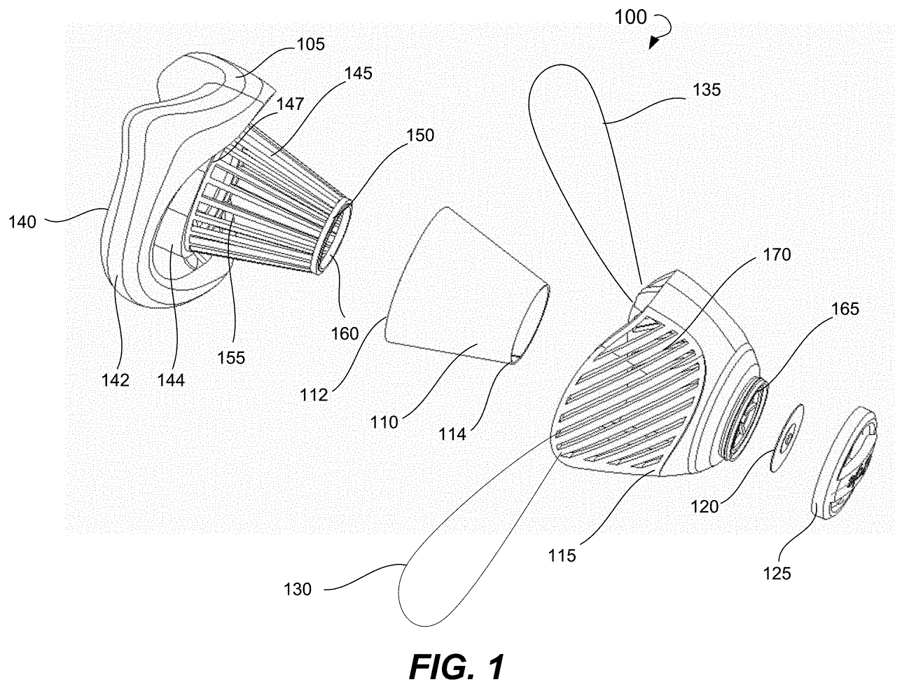

Referring now to the drawings, FIG. 1 is an exploded view of a nasal mask assembly 100, according to one example embodiment of the present disclosure. The nasal mask assembly 100 may include a first part 105, a filter 110, a second part 115, a one-way valve 120, a valve cap 125, and two ear straps 130 and 135.

The first part 105 may include a base 140 and a filter support 145 extending from the base 140. The base 140 may include a first base part 142 and a second base part 144 connected to each other. The first base part 142 of the base 140 can be configured to engage a face surface around a nose of a user. The first base part 142 can be made of a soft material having a predetermined hardness and a predetermined strength to provide soft contact between the base 140 and the face surface around the nose and the nose itself. The soft material may include a material having a predetermined hardness and a predetermined strength to provide soft contact between the base 140 and the face surface of the user. The soft material may include a polymer-based material, a silicone material, a rubber-based material, and the like. Furthermore, the soft material may also provide wearing comfort to the user wearing the nasal mask assembly 100. The usage of the silicone material may allow sealing gaps between the base 140 and the face surface and the nose. The base 140 can be of a triangle-like shape similar to the shape of a nose. The second base part 144 may be configured to engage the second part 115 of the nasal mask assembly 100. The second base part 144 may be made of a hard-plastic material or a soft material having a predetermined hardness and a predetermined strength (e.g., a silicone material) to support the sealing of the first base part 142 and the filter 110.

In an example embodiment, the first part 105 and the second part 115 can be connected to each other via one or more fixing elements, for example, clips. The one or more fixing elements can be provided on at least one of the first part 105 and the second part 115.

The filter support 145 can be connected to the second base part 144. The filter support 145 and filter 110 placed on the filter support 145 form a breathing chamber for the nose of the user. The filter support 145 can be made of a hard-plastic material or a relatively hard silicone material. The filter support 145 may include at least one outlet 150 and at least one inlet 155. In the example of FIG. 1, the filter support 145 is of a conical shape and includes multiple inlets 155 along the side surface of the conical shape. The portion 160 around the outlet 150 of the filter support 145 surrounds a tip of the outlet 150 and also surrounds portions of the outlet 150 located inwardly and outwardly with respect to the tip of the outlet 150. The portion 160 is configured to engage internal surface of the second part 115. The portion 160 can be made of a soft material, such as a silicone material, or ethylene-vinyl acetate cotton to seal gaps between the portion 160 around the outlet 150 (i.e., a tip of the breathing chamber and the portions of the outlet 150 located inwardly and outwardly with respect to the tip of the outlet 150) and the internal surface of the second part 115 such that there is no unfiltered air leaking to the breathing chamber.

The filter 110 can be made of a porous material for filtering out particles from the air. In particular, filter 110 can be made of a material which filters particles having a size/diameter that is less than a predetermined size/diameter, including but not limited to particulate matter having a diameter of less than 10 micrometers (PM10) or less than 2.5 micrometers (PM2.5), dust, pollen, pet dander, tobacco smoke, airborne pollutants, and other pollutants. In some embodiments, the filter 110 can be made of polypropylene. The shape of the filter 110 may substantially adopt the shape of the filter support 145. When placed on the filter support 145, the filter 110 covers the inlet 155 of the filter support 145 and leaves the outlet 150 open. In the example of FIG. 1, the filter 110 is designed as a conical sleeve and can be put on the filter support 145 from the top down. The filter 110 may include small portions of a non-porous material at the top and the bottom for sealing the gaps between the filter 110 and the filter support 145. In a preferred embodiment, at least the portion 160 (i.e., a top end) and the bottom end 147 of the filter support 145 are made of a non-porous material without holes for sealing the gap or leaks between the filter 110 and the filter support 145.

In some embodiments, in addition to filtering out particles from the air, the filter 110 can be sprayed with some medicinal liquid for treatment of respiratory and other diseases. For example, anti-inflammatory drugs can be sprayed on the filter 110. In certain embodiments, a medicine in a solid form can be placed between the filter 110 and the second part 115 to allow treatment of respiratory and other diseases. The medicine may include aromatherapy tablets.

In other embodiments, the filter support 145 and the filter 110 can be of different shapes. The example shapes of the filter support 145 and the filter 110 may include a conical shape with a circular base and a polygon pyramid shape with any of a square base, a rounded square base, a triangle base, a rounded triangle base, a regular polygon base, a pentagon base, a hexagon base, and the like. The filter support 145 and the filter 110 having the conical shape may have no edges. The filter support 145 and the filter 110 having the polygon pyramid shape may have round or curved edges (i.e., vertical edges of the pyramid). The shape of the filter support 145 and the filter 110 may have no top portion, i.e. may be carried out as a truncated cone or truncated pyramid to provide the airflow from the breathing chamber to the one-way valve 120 of the nose nasal assembly 100.

These types of shapes have one common characteristic, namely the cross-sectional area of the filter 110 decreases continuously from a bottom end 112 of the filter 110 (where the filter 110 has the largest cross-sectional area) to a top end 114 of the filter 110 (where the filter 110 has the smallest cross-sectional area) such that the filter 110 is tighter and sealed better as the filter 110 is inserted and pushed in closer to a bottom end 147 of the filter support 145 and there is no air leak between the filter 110 and the filter support 145 or no unfiltered air leaking to the breathing chamber without first passing through the filter 110. The filter 110 may be secured on the filter support 145 from falling off by the second part 115 when the second part 115 is connected to the first part 105.

A three-dimensional (3D) conical shape having a circle base can be preferable for the filter 110 and the filter support 145 because the area of a 3D conical filter is always greater than that of a plane circular filter (two-dimensional (2D)) filter provided that their base areas (i.e., a diameter of a base) are the same. In some example configurations of the 3D conical filter, the area of a conical filter area can be 4.56 times as compared to the area of a circular filter (2D). For example, a 2D circular filter with an exhalation outlet used in conventional face masks may have 40 millimeters (mm) external diameter and 22 mm inner diameter (for the exhalation outlet). Area of such 2D circular filter is 876 square millimeters (mm²). An area of a 40 mm diameter 2D circular filter without exhalation outlet is 1256 mm². In comparison, if a 3D conical filter has a bottom end of 40 mm diameter, a top end of 22 mm diameter, and 40 mm of height (equals to the distance between the bottom end and the top end that forms an exhalation outlet), then area of the 3D conical filter is 3990 mm². Thus, the 3D conical filter's area is 3.18 times more than an area of the 2D circular filter without exhalation outlet and 4.56 times more than an area of the 2D circular filter with exhalation outlet, respectively. Thus, the efficiency level of a 3D conical filter is higher and a lifetime is longer than those of a 2D filter due to a larger surface area of the 3D conical filter. Another advantage of the 3D conical filter is creating a breathing chamber via the filter support to facilitate better breathing of the user.

The filter support 145 of a conical shape forms a breathing chamber for the nose of the user. The conical shape of the breathing chamber may allow the user to inhale air already in the breathing chamber, which is easier to inhale.

In an example embodiment, the filter support 145 and the filter 110 can be substantially of a planar shape. If the filter support 145 and the filter 110 have a planar shape, no breathing chamber is formed by the filter support 145 and the filter 110.

The second part 115 can be configured to engage the base 140, the outlet 150, and the portion 160 of the filter support 145 to seal the gaps between the first part 105 and the second part 115. The second part 115 can be also cover the combination of the filter support 145 and the filter 110 placed on the filter support 145. The second part 115 may include an outlet 165 and at least one inlet 170. When the second part 115 engages the base 140 and the outlet 150 and covers the filter support 145 and filter 110, the outlet 165 is positioned against the outlet 150 of the filter support 145. In the example of FIG. 1, the at least one inlet 170 of the second part 115 is carried out as a mesh of inlets. In other embodiments, the second part 115 may be of different shapes. The inlets in the mesh can be of different shapes and combinations of shapes: round, oval, ellipse, conical, and so forth.

The one-way valve 120 can be a one-way breathing valve configured to be positioned in the outlet 165. In some embodiments, the one-way valve can be secured by a valve cap 125. The valve cap 125 may include one or more openings for airflow. In other embodiments, the one-way valve 120 can be configured to be secured in the outlet 165 without the valve cap 125.

In some embodiments, the one-way valve 120 may include a silicone check valve. The one-way valve 120 can be configured to allow an airflow from the breathing chamber formed by the filter support 145 and prevent airflow flowing inside the breathing chamber. Thus, the one-way valve 120 is closed when the user is inhaling and is open when the user is exhaling.

In further embodiments, the filter support 145 may include multiple outlets and the second part 115 may include multiple outlets positioned against the outlets of the filter support 145. Correspondently, multiple one-way valves can be installed within the multiple outlets of the second part 115 to allow the user to exhale easier.

The ear straps 130 and 135 can be attached to the sides of the second part 115. The ear straps 130 and 135 can be configured to be adjustable in length and/or elastic to allow the user to secure the combination of the first part 105, the filter 110, and the second part 115 to face surface around the nose of the user. In another example embodiment, the ear straps 130 and 135 may be made of a non-elastic material and/or adjustable in length. In other embodiments, straps of a different type can be used instead of the ear straps 130 and 135. In a preferred embodiment, the first part 105 and the second part 115 can be connected to each other via fixing elements, such as clips, pre-built on at least one of the first part 105 and the second part 115.

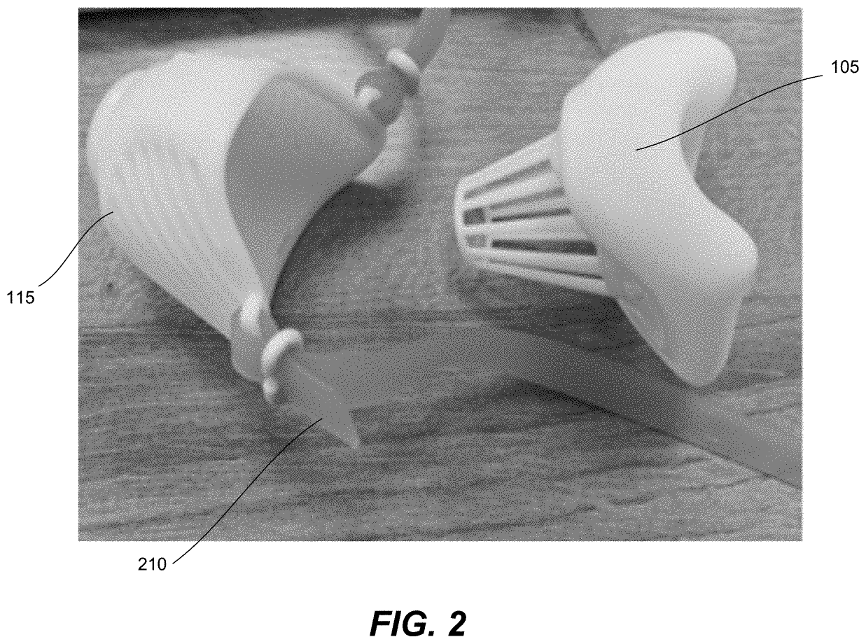

FIG. 2 shows a first part 105 and a second part 115 of a nasal mask assembly, according to some example embodiments. In the example of FIG. 2, a head strap 210 is used instead of ear straps to secure the combination of the first part 105, the filter 110 (shown in FIG. 1), and the second part 115 to the face surface around the nose of the user. The head strap 210 can be configured to be adjustable in length and/or may be made of an elastic material. In another example embodiment, the head strap 210 may be made of a non-elastic material and/or adjustable in length.

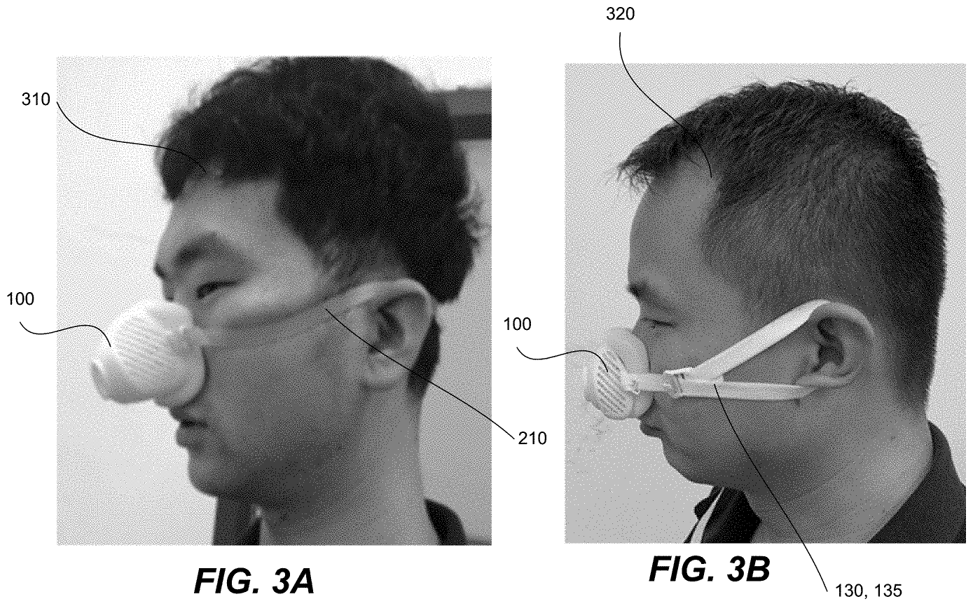

FIG. 3A shows a user 310 wearing the nasal mask assembly 100. In the example of FIG. 3A, the combination of the first part 105 (shown in FIG. 1 and FIG. 2), the filter 110 (shown in FIG. 1), and the second part 115 (shown in FIG. 2) is secured to the face surface around the nose of the user 310 via the head strap 210.

FIG. 3B shows a user 320 wearing the nasal mask assembly 100. In the example of FIG. 3B, the combination of the first part 105 (shown in FIG. 1 and FIG. 2), the filter 110 (shown in FIG. 1), and the second part 115 (shown in FIG. 2) is secured to the face surface around the nose of the user 320 via the ear straps 130 and 135. The ear straps 130 and 135 may be adjustable and elastic or adjustable and non-elastic.

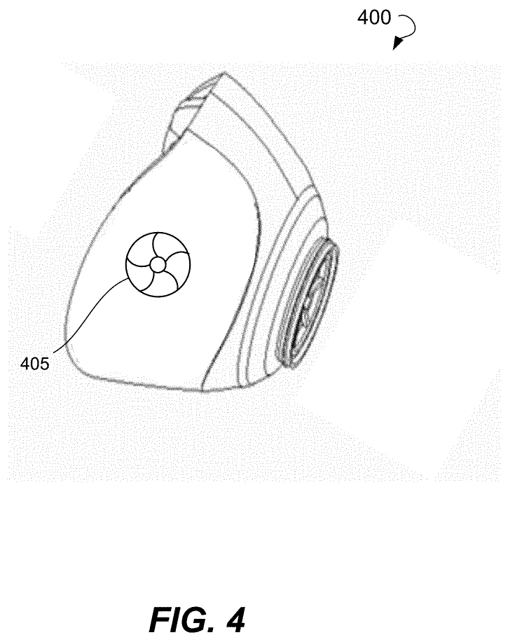

FIG. 4 shows a second part 400 of the nasal mask assembly, according to some example embodiments. The difference of the second part 400 from the second part 115 shown in FIG. 1 and FIG. 2 is that the second part 400 may not include inlets. Instead of inlets or in addition to the inlets, the second part 400 may include an electrically driven fan 405 configured to pump air towards the breathing chamber formed by the filter 110 and the filter support 145 (shown in FIG. 1). The electrically driven fan 405 can be powered by a power supply installed within the second part 400 or by an external power source. The air passing through the electrically driven fan 405 passes through the filter 110 and enters the breathing chamber to ensure that the air in the breathing chamber is clean when the user is breathing.

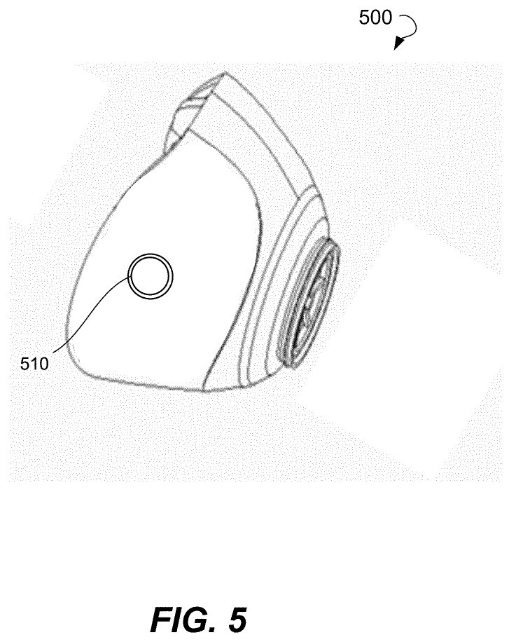

FIG. 5 shows a second part 500 of the nasal mask assembly, according to some example embodiments. The difference of the second part 500 from the second part 115 shown in FIG. 1 and FIG. 2 is that the second part 500 may include one or more inlets 510 configurable to receive a hose. The hose may supply an airflow from an external air pumping device. The airflow from the external air pumping device may include a purified air, an oxygen enriched air, an air enriched with vapors of a liquid medicine for treatment of a respiratory disease, and so forth.

Referring to FIG. 1, in some embodiments, the nasal mask assembly 100 may include a breathing sensor for exhaled air. The breathing sensor for exhaled air can be placed, for example, in the outlet 165 of the second part 115 instead of the one-way valve 120 or in addition to one-way valve 120. The nasal mask assembly 100 may include a breathing sensor for inhaled air. The breathing sensor for inhaled air can be placed, for example, on or near the at least one inlet 170 of the second part 115. Each of breathing sensors may be configured to sense a strength and rate of the user's breathing. The data sensed by each of the breathing sensors can be further used to predict indication of respiratory diseases and other problems with the breathing of a user wearing the nasal mask assembly 100.

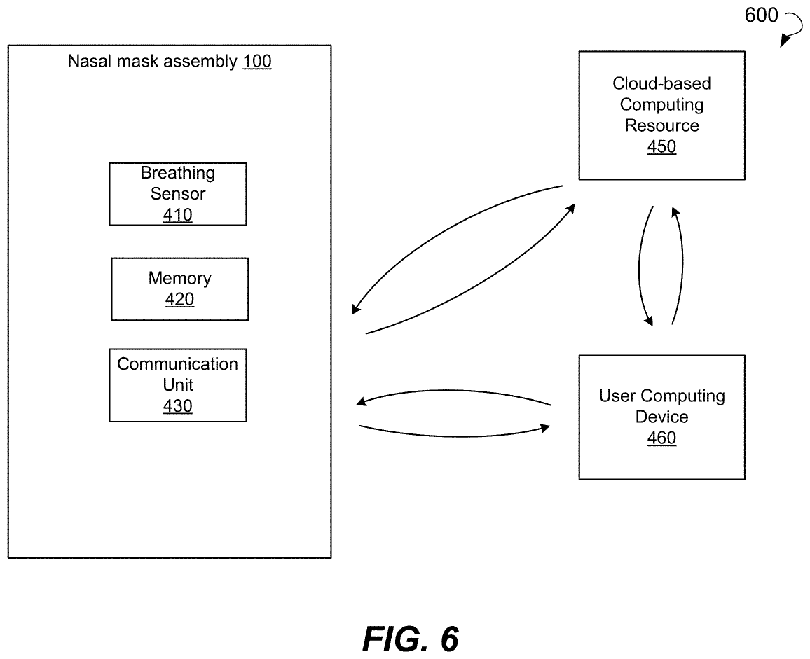

FIG. 6 is a block diagram showing an example system 600 for monitoring and processing a user's breathing data using a nasal mask assembly. The system 600 may include a nasal mask assembly 100, a cloud-based computing resource 450, and a user computing device 460.

The nasal mask 100 may include a breathing sensor 410 and a communication unit 430 communicatively coupled to the breathing sensor 410. The breathing sensor can be installed within the outlet 165 and/or on the at least one inlet 170 of the second part 115 of the nasal mask assembly 100. In some embodiments, the breathing sensor 410 may include a microelectromechanical system to sense airflow within the outlet 165 and an electronic circuit. The electronic circuit may be configured to convert the data from the microelectromechanical system to a sensor data (in a digital format) including a rate and strength of breathing of a user wearing the nasal mask assembly 100. In some embodiments, the nasal mask 100 may also include a memory 420 for storing the sensor data from the breathing sensor 410.

The communication unit 430 may include a radio transmitter configured to transmit the sensor data provided by the breathing sensor. The communication unit 430 may be configured to transmit the sensor data via one or more wireless protocols. The wireless protocols may include Bluetooth™. In an example embodiment, a wired transmitter can be used instead of the radio transmitter. A wire connector can be provided for the wired transmitter, e.g., via one of the straps. The sensor data can be further provided, via a data network, to the cloud-based computing resource 450 and/or the user computing device 460. The communication unit 430 may also include a radio receiver configured to receive data and commands, via the data network, from the cloud-based computing resource 450 and/or the user computing device 460. The data may include a command to the communication unit 430 to transmit sensor data currently stored in the memory 420.

The cloud-based computing resource 450 can include hardware and software available at a remote location and accessible over the data network. The cloud-based computing resource 450 can be dynamically re-allocated based on demand. Cloud-based computing resources may include one or more server farms/clusters including a collection of computer servers which can be co-located with network switches and/or routers. The user computing device 460 may include a desktop computer, a laptop, a tablet computer, a smart phone, a smart watch, and so forth.

The digital data from the breathing sensor 410 can be analyzed on the cloud-based computing resource 450. The result of analysis can be further viewed by a user via the user computing device 460. In other embodiments, the digital data from the breathing sensor 410 can be analyzed directly on the user computing device 460.

The cloud-based computing resource 450 and/or the user computing device 460 may include a memory and at least one processor. The memory may store software applications for analyzing the sensor data from the breathing sensor 410. The software applications can be stored in a form of instructions executable by the processor.

In some embodiments, after measurements, the sensor data can be stored in the memory 420 located in the nasal mask assembly 100. With permission of a user of the nasal mask assembly 100, the sensor data can be uploaded to the cloud-based computing resource 450 for storage. The sensor data can be further provided to the user computing device 460 for analyzing.

In other embodiments, the sensor data can be directly transmitted to the user computing device 460. The user computing device 460 may store the sensor data and upload the sensor data to the cloud-based computing resource 450 for analyzing.

In some embodiments, the sensor data can be accumulated on the user computing device 460 or the cloud-based computing resource 450 during a predetermined time period. The sensor data can be further analyzed to determine the breathing pattern of the user wearing the nasal mask assembly 100. The trends or changes in the breathing pattern can be further analyzed to predict one or more respiratory diseases the user may suffer from.

In some embodiments, the analysis of the breathing pattern(s) may include a determination that the breathing pattern exceeds a normal breathing pattern by a predetermined threshold. Upon the determination, an alert can be sent to a smart phone or other device of the user's family member(s) or personnel treating the user. The alert may include indications to take timely actions for treating the user's respiratory diseases.

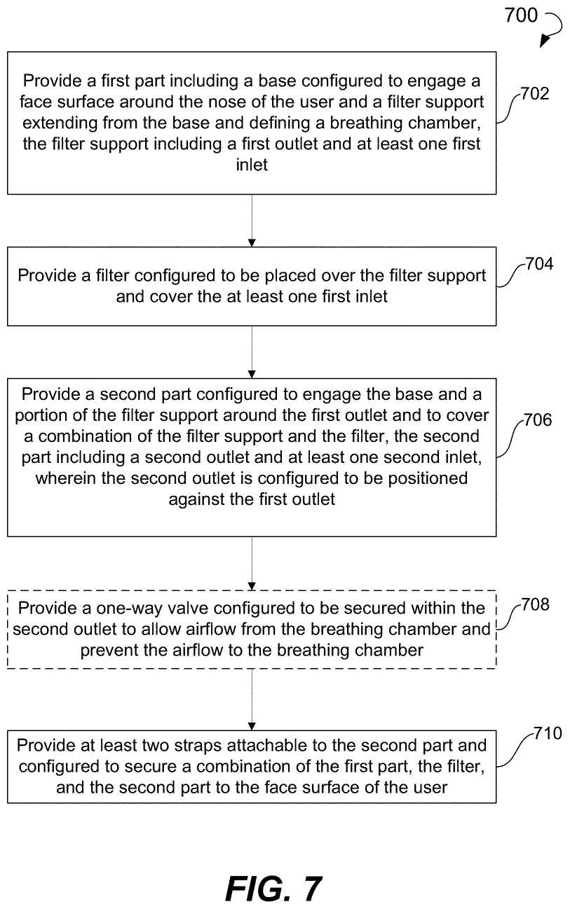

FIG. 7 is a flow chart showing a method 700 for providing a nasal mask assembly, according to some example embodiments. The method 700 may commence, in block 702, with providing a first part. The first part may include a base configured to engage a face surface around a nose of a user. The base may include a first base part and a second base part connected to each other. The first base part can be configured to engage the face surface around the nose of the user and the second base part may be configured to engage the second part. The first part may further include a filter support extending from the base and defining a breathing chamber. The filter support may include a first outlet and at least one first inlet.

In block 704, the method 700 may include providing a filter configured to be placed over the filter support and to cover the first inlet.

In block 706, the method 700 may include providing a second part. The second part can be configured to engage the base and a portion of the filter support around the first outlet. The second part can be configured to cover a combination of the filter support and the filter. The second part may include a second outlet and at least one second inlet. The second outlet can be configured to be positioned against the first outlet. The second part can be connected to the first part via one or more fixing elements provided on at least one of the second part and the first part.

In block 708, the method 700 may, optionally, include providing a one-way valve configured to be secured within the second outlet. The one-way valve can allow airflow from the breathing chamber and prevent the airflow to the breathing chamber.

In block 710, the method 700 may include providing at least two straps attachable to the second part and configured to secure a combination of the first part, the filter, and the second part to the face surface of the user.

Thus, a nasal mask assembly is described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A nasal mask assembly comprising:
a first part including:
a base configured to engage a face surface around a nose of a user; and
a filter support extending from the base and defining a breathing chamber, the filter support including a first outlet and at least one first inlet;
a filter configured to be placed over the filter support and cover the at least one first inlet;
a second part configured to:
engage the base and a portion of the filter support around the first outlet; and
cover a combination of the filter support and the filter, the second part including a second outlet and at least one second inlet, wherein the second outlet is configured to be positioned against the first outlet; and
at least two straps attachable to the second part and configured to secure a combination of the first part, the filter, and the second part to the face surface of the user.

2. The nasal mask assembly of claim 1, further comprising a one-way valve configured to be secured within the second outlet to allow airflow from the breathing chamber and to prevent airflow to the breathing chamber.

3. The nasal mask assembly of claim 2, wherein the one-way valve includes a silicone check valve.

4. The nasal mask assembly of claim 1, wherein the filter support is made of one of a hard-plastic material or a soft material having a predetermined hardness and a predetermined strength.

5. The nasal mask assembly of claim 1, wherein the base includes a first base part and a second base part connected to each other, wherein the first base part is configured to engage the face surface around the nose of the user and wherein the second base part is configured to engage the second part.

6. The nasal mask assembly of claim 5, wherein the first base part is made of a first soft material to seal gaps between the face surface of the user and the first base part, and wherein the second base part is made of one of the following: a hard-plastic material and a second soft material having a predetermined hardness and a predetermined strength, wherein the second base part is configured to support the filter and the filter support.

7. The nasal mask assembly of claim 1, wherein the first part and the second part are connected to each other via one or more fixing elements, the one or more fixing elements being provided on at least one of the first part and the second part.

8. The nasal mask assembly of claim 1, wherein the filter support and the filter are substantially of one of the following shapes: a conical shape and a polygon pyramid shape.

9. The nasal mask assembly of claim 1, wherein the filter support and the filter are substantially of a planar shape.

10. The nasal mask assembly of claim 1, wherein the portion of the filter support around the first outlet is made of a soft material, wherein the portion of the filter support surrounds a tip of the first outlet and surrounds portions of the first outlet located inwardly and outwardly with respect to the tip of the first outlet; and
wherein a portion of the second part engaging the portion of the filter support around the first outlet is made of a hard-plastic material.

11. The nasal mask assembly of claim 1, wherein the filter support of the first part is made of a hard-plastic material, and wherein a portion of the second part engaging the filter support of the first part is made of a soft material.

12. The nasal mask assembly of claim 1, wherein the at least two straps include one of the following: head straps and ear straps, wherein each of the head straps and the ear straps:
is made of an elastic material, each of the head straps and the ear straps being adjustable in length, or
is made of a non-elastic material, each of the head straps and the ear straps being adjustable in length.

13. The nasal mask assembly of claim 1, wherein the filter is made of a material configured to perform at least one of the following:
filter particles having a diameter less than a predetermined diameter; and
be moistened with at least one liquid medicine.

14. The nasal mask assembly of claim 1, wherein the at least one second inlet of the second part includes a mesh of openings.

15. The nasal mask assembly of claim 1, further comprising at least one electrically driven fan installed within the at least one second inlet, the electrically driven fan being configured to pump air towards the filter and the filter support.

16. The nasal mask assembly of claim 1, wherein the at least one second inlet is configured to receive at least one hose, the at least one hose being configured to provide an airflow from an external air pump device.

17. The nasal mask assembly of claim 1, further comprising at least one of the following:
a first breathing sensor for exhaled air installed within the second outlet; and
a second breathing sensor for inhaled air installed on the at least one second inlet,
wherein each of the first breathing sensor and the second breathing sensor is configured to measure sensor data including a frequency and a strength of breathing of the user.

18. The nasal mask assembly of claim 17, further comprising a radio transmitter installed inside the second part and coupled with at least one of the first breathing sensor and the second breathing sensor, the radio transmitter being configured to transmit the sensor data to at least one computing device.

19. A method for providing a nasal mask assembly, the method comprising:
providing a first part including:
a base configured to engage a face surface around a nose of a user; and
a filter support extending from the base and defining a breathing chamber, the filter support including a first outlet and at least one first inlet;
providing a filter configured to be placed over the filter support and cover the at least one first inlet;
providing a second part configured to:
engage the base and a portion of the filter support around the first outlet; and
cover a combination of the filter support and the filter, the second part including a second outlet and at least one second inlet, wherein the second outlet is configured to be positioned against the first outlet; and
providing at least two straps attachable to the second part and configured to secure a combination of the first part, the filter, and the second part to the face surface of the user.

20. A nasal mask assembly comprising:
a first part including:
a base configured to engage a face surface around a nose of a user; and
a filter support extending from the base and defining a breathing chamber, the filter support including a first outlet and at least one first inlet;
a filter configured to be placed over the filter support and cover the at least one first inlet;
a second part configured to:
engage the base and a portion of the filter support around the first outlet; and
cover a combination of the filter support and the filter, the second part including a second outlet and at least one second inlet, wherein the second outlet is configured to be positioned against the first outlet;
a one-way silicone valve configured to be placed within the second outlet to allow airflow from the breathing chamber and to prevent airflow to the breathing chamber;
a first breathing sensor for exhaled air configured to be positioned within the second outlet and a second breathing sensor for inhaled air configured to be positioned on the at least one second inlet, the first breathing sensor and the second breathing sensor being configured to measure sensor data including a frequency and a strength of breathing of the user;
a valve cap being configured to secure one of the one-way silicone valve or the breathing sensor to the second outlet, the valve cap including at least one opening; and
at least two straps attachable to the second part and configured to secure a combination of the first part, the filter, and the second part to the face surface of the user.
